(19) United States
(12) Patent Application Publication
(10) Pub. No.: US 2026/0303726 A1
(43) Pub. Date: Oct. 1, 2026

(54) Systems and Methods for Smart Call Management

(71) Applicant: TEACHERS INSURANCE AND ANNUITY ASSOCIATION OF AMERICA, New York, NY (US)

(72) Inventors: Rajesh Singh, Charlotte, NC (US); Nitin Saxena, Charlotte, NC (US); Sreeni Kandikonda, Charlotte, NC (US); Bharat Gupta, Pune (IN); Shafiq N. Kassam, Lewisville, TX (US)

(21) Appl. No.: 19/092,771

(22) Filed: Mar. 27, 2025

(51) Int. Cl. H04M 3/523; G10L 15/06; G10L 15/18; G10L 15/183; G10L 15/30; H04M 3/51

(52) U.S. Cl. CPC H04M 3/5235; G10L 15/063; G10L 15/1815; G10L 15/183; G10L 15/30; H04M 3/5175; H04M 3/5191

(57) ABSTRACT

Systems and methods for optimizing customer service efficiency are provided. Example techniques may include: obtaining pre-existing customer service-related data from one or more integrated data sources; storing the obtained pre-existing customer service-related data in a local repository; generating, by inputting a call context into a generative artificial intelligence (AI) model, information related to a user call including: an intent, a call summary, client recent activities, solutions based on previous recommendations, relevant pre-existing documents, and/or next best actions, wherein the generative AI model was trained by inputting the stored pre-existing customer service data into the generative AI model; and sending the generated information related to a user call to an agent before a user is connected with the agent.

### FIELD

The present disclosure generally relates to smart call management through computer-implemented methods and systems, and more particularly relates to analyzing pre-existing and/or real-time customer service-related data using generative AI models to improve agent-user interactions, such as determining user intent and providing agents with relevant information before connecting with a user.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Customer contact centers, especially those at large scale, often face the challenge of efficiently handling customer calls. Conventional contact center systems struggle to ensure both customer satisfaction and operational cost-effectiveness. More specifically, prolonged call durations frequently result from contact center agents spending considerable time gathering basic information from the caller, which the caller may have previously provided through other channels such as interactive voice response (IVR) systems. For example, when the caller provides information regarding the intent of the call through the IVR systems, if the automated system cannot solve the request and needs to transfer the call to an agent, the caller often needs to repeat their request to the agent. Furthermore, the lack of readily available and actionable insights complicates the agent’s ability to swiftly navigate to and provide effective solutions, further exacerbating the issue of increased average handle time (AHT).

These challenges underscore the need for continued innovation in contact center technology to reduce average handle times, improve customer experience, and achieve operational efficiencies. Consequently, there exists a significant opportunity for the development of improved platforms and technologies aimed at solving the identified conventional problems by delivering more contextual and actionable information to agents in real-time, thereby optimizing the call handling process.

In one aspect, a computer-implemented method for optimizing customer service efficiency may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, and/or other electronic or electrical components, which may be in wired or wireless communication with one another. For instance, in one example, the computer-implemented method may include: (1) obtaining, via one or more processors, pre-existing customer service-related data from one or more integrated data sources; (2) storing, via the one or more processors, the obtained pre-existing customer service-related data in a local repository; (3) generating, via the one or more processors, by inputting a call context into a generative artificial intelligence (AI) model, information related to a user call including: an intent, a call summary, client recent activities, solutions based on previous recommendations, relevant pre-existing documents, and/or next best actions, wherein the generative AI model was trained by inputting the stored pre-existing customer service data into the generative AI model; and (4) sending, via the one or more processors, the generated information related to a user call to an agent before a user is connected with the agent.

The method may include additional, fewer, or alternate actions, including those discussed elsewhere herein.

In another aspect, a computer device configured for optimizing customer service efficiency may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, and/or other electronic or electrical components, which may be in wired or wireless communication with one another. For example, in one instance, the computer device may include one or more processors configured to: (1) obtain pre-existing customer service-related data from one or more integrated data sources; (2) store the obtained pre-existing customer service-related data in a local repository; (3) generate, by inputting a call context into a generative artificial intelligence (AI) model, information related to a user call including: an intent, a call summary, client recent activities, solutions based on previous recommendations, relevant pre-existing documents, and/or next best actions, wherein the generative AI model was trained by inputting the stored pre-existing customer service data into the generative AI model; and (4) send the generated information related to a user call to an agent before a user is connected with the agent.

The computer device may include additional, less, or alternate functionality, including that discussed elsewhere herein.

In yet another aspect, a computer system configured for optimizing customer service efficiency may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) obtain pre-existing customer service-related data from one or more integrated data sources; (2) store the obtained pre-existing customer service-related data in a local repository; (3) generate, by inputting a call context into a generative artificial intelligence (AI) model, information related to a user call including: an intent, a call summary, client recent activities, solutions based on previous recommendations, relevant pre-existing documents, and/or next best actions, wherein the generative AI model was trained by inputting the stored pre-existing customer service data into the generative AI model; and (4) send the generated information related to a user call to an agent before a user is connected with the agent.

The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an example computer system in which methods and systems for smart call management to improve agent-user interactions are implemented, according to one embodiment.

FIG. 2 depicts an example agent interface that can be produced, according to an embodiment.

FIGS. 3A and 3B in combination depict a combined block and logic diagram in which example computer-implemented methods and systems for smart call management to improve agent-user interactions are implemented, according to one embodiment

FIG. 4 depicts a flow diagram of an example computer-implemented method for smart call management to improve agent-user interactions, according to one embodiment.

FIG. 5 depicts a flow diagram of an example computer-implemented method for processing user session information in a contact center system, according to one embodiment.

FIG. 6 depicts a flow diagram of generating information related to a user call using generative AI model, according to one embodiment.

FIG. 7 depicts an example combined block and logic diagram for example training of an example chatbot.

### DETAILED DESCRIPTION

The present embodiments relate to, inter alia, using artificial intelligence (AI) and/or machine learning (ML) to determine a caller's intent and provide agents with relevant information before connection with the caller. For example, a user may call the contact center system to make a change in the user's profile (e.g., change the address on profile). After the user enters information based on the automated prompts and after the automated system determines that the request cannot be completed automatically, the disclosed system, utilizing AI or ML models, may determine the user intent, generate relevant information, and send the intent and/or relevant information to an agent before the user is connected with the agent. For instance, the intent and/or relevant information may be automatically pre-filled onto the agent’s screen prior to, or simultaneous with, the agent being connected with the users. This approach not only reduces the handling time from the agent, but also enhances the quality of customer service by enabling agents to provide more accurate and timely resolutions.

### Exemplary Computer System – Smart Call Management

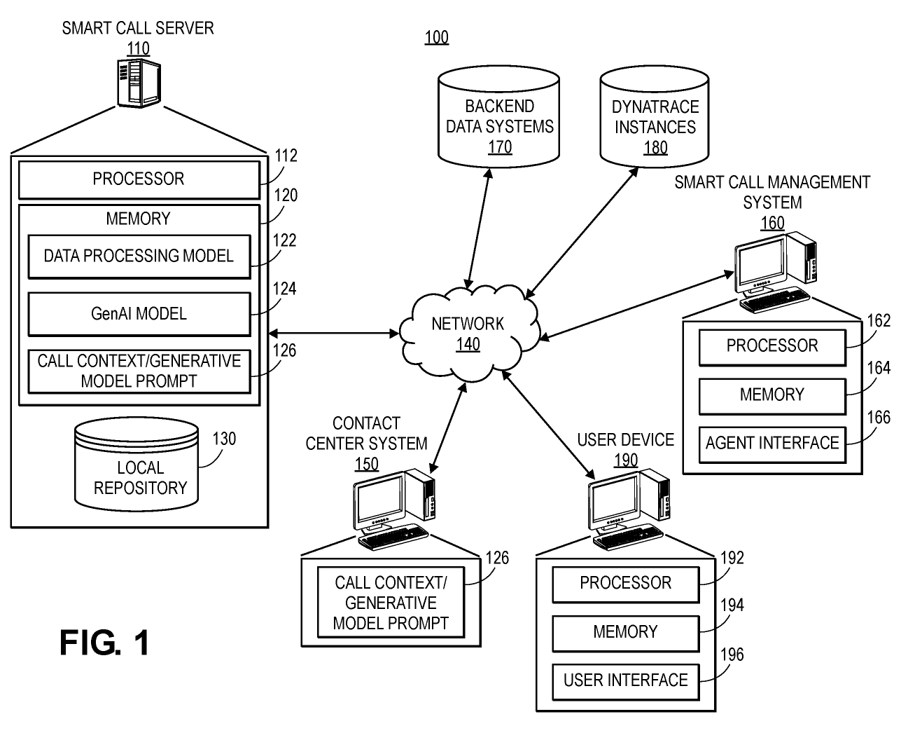

To this end, FIG. 1 illustrates an exemplary computer system 100 for smart call management in which the exemplary computer-implemented methods described herein may be implemented, according to one embodiment. The high-level architecture may include both hardware and software applications, as well as various data communications channels for communicating data between the various hardware and software components.

The system 100 may include a smart call server 110. The smart call server 110 may include one or more processors 112 such as one or more microprocessors, controllers, and/or any other suitable type of processor. The smart call server 110 may further include a memory 120 (e.g., volatile memory, non-volatile memory) accessible by the one or more processors 112, (e.g., via a memory controller). The one or more processors 112 may interact with the memory 120 to obtain and execute, for example, computer-readable instructions stored in the memory 120. Additionally or alternatively, computer-readable instructions may be stored on one or more removable media (e.g., a compact disc, a digital versatile disc, removable flash memory, etc.) that may be coupled to the smart call server 110 to provide access to the computer-readable instructions stored thereon. In particular, the computer-readable instructions stored on the memory 120 may include instructions for executing various applications, such as data processing model 122, generative AI model 124, and/or call context/generative model prompt 126.

In operation, the data processing model 122 may obtain and normalize (pre-existing and/or real-time customer) customer service-related data, and store the normalized data on a local repository 130 on the smart call server 110. As will be described elsewhere herein, the stored data may be used to train the generative AI model 124. It should be understood that the generative AI model 124 may be included in a chatbot (or voicebot).

The customer service-related data may be obtained from various integrated data sources, including contact center system 150 (e.g., information extracted from the user call), backend data systems 170 (e.g., recent activities of the user), and application monitoring systems, such as Dynatrace Instances 180 (e.g., service instance records).

When a user makes a customer service call through a contact center system 150, the user device 190 may also be connected to the system 100 via a computer network 140 if the user has started a user session via the company website. This enables functions for an agent to better assist the user if later connected to an agent. For instance, if the user authorizes the co-browsing function, the agent will be able to view the user's interface to help them navigate the website to fulfill the user's request. Each of the user devices 190 may include, e.g., smart phones, smart watches or fitness tracker devices, tablets, laptops, virtual reality headsets, smart or augmented reality glasses, wearables, other personal computers, etc. The user devices 190 may include, or may be configured to communicate with, a user interface 196 (which may include a display device, etc.), which may receive input from users and may provide audible or visible output to users. Additionally, the user devices 190 may include one or more processors 192, as well as one or more computer memories 194. Memories 194 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memories 194 may store an operating system (OS) (e.g., iOS, Microsoft Windows, Linux, UNIX, etc.) capable of facilitating the functionalities, apps, methods, or other software as discussed herein.

The smart call server 110 may send the generated information related to the user call (e.g., call summary, client recent activities, solutions based on previous recommendations, relevant pre-existing documents, next best actions, and/or co-browse link) to the agent via a smart call management system 160. The smart call management system 160 may include, or may be configured to communicate with, an agent interface 166 (which may include a display device, etc.), which may receive input from users and may provide audible or visible output to users. Additionally, the smart call management system 160 may include one or more processors 162, as well as one or more computer memories 164. Memories 164 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memories 164 may store an operating system (OS) (e.g., iOS, Microsoft Windows, Linux, UNIX, etc.) capable of facilitating the functionalities, apps, methods, or other software as discussed herein.

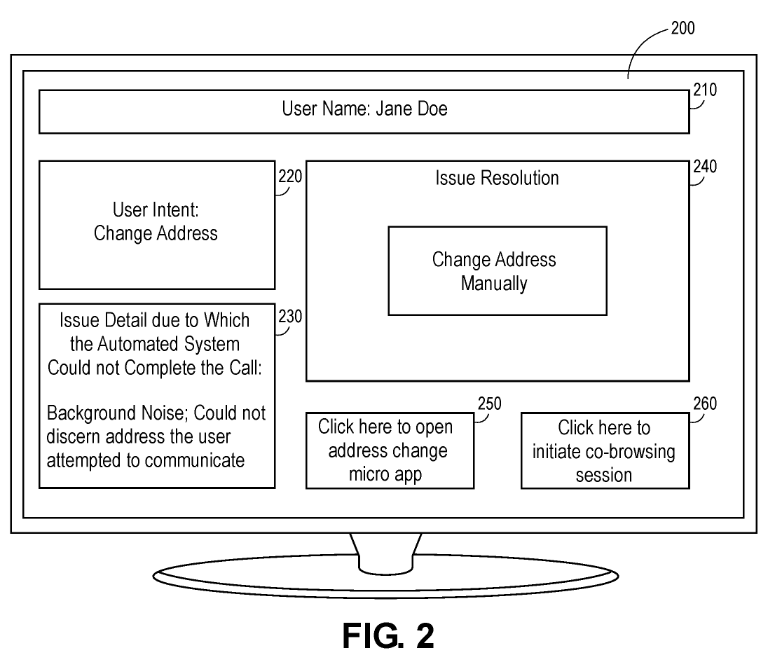

In operation, the agent interface 166 may provide the agent with valuable information. For instance, FIG. 2 illustrates an example screen 200 that may be displayed to the agent. The example screen 200 may include: a name of the user/caller 210; an intent 220, an issue detail 230; a suggested issue resolution 240; and a link 250 (e.g., to a website, microapp, etc.) to resolve the issue.

The smart call server 110, the contact center system 150, the smart call management system 160, the backend data systems 170, the Dynatrace Instances 180 and the user devices 190 may be configured to communicate with one another via a wired or wireless computer network 140. The network 140 may comprise any suitable network or networks, including a local area network (LAN), wide area network (WAN), Internet, or combination thereof. For example, the network 140 may include a wireless cellular service (e.g., 4G, 5G, 6G, etc.). Although one smart call server 110, one contact center system 150, one smart call management system 160, one backend data systems 170, one Dynatrace Instances 180, one user devices 190, and one network 140 are shown in FIG. 1, any number of such smart call servers 110, contact center system 150, smart call management systems 160, backend data systems 170, Dynatrace Instances 180, user devices 190, and networks 140 may be included in various embodiments.

### Exemplary Workflow for Smart Call Management

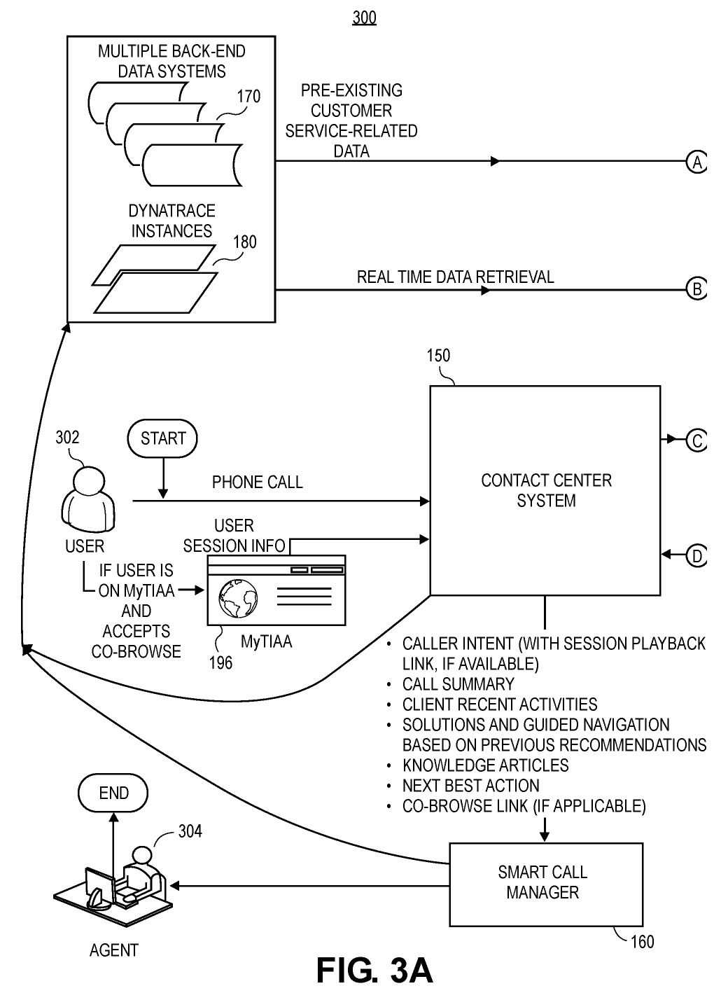

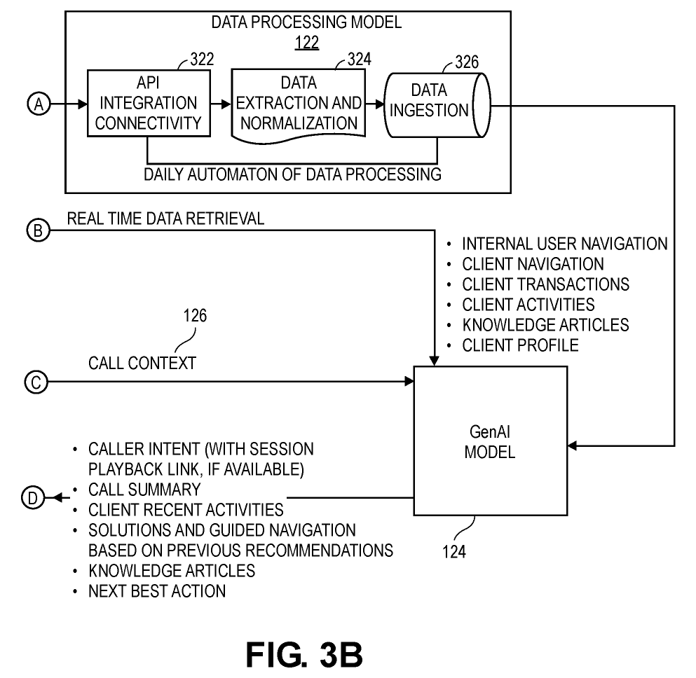

FIGS. 3A and 3B in combination illustrate a combined block and logic diagram in which exemplary computer-implemented methods and systems for smart call management are implemented. Some of the blocks in FIGS. 3A and 3B may represent hardware and/or software components, and other blocks may represent data structures or memory storing these data structures (e.g., 170, 180).

As illustrated, in one embodiment, the smart call server 110 obtains customer service-related data from one or more integrated data sources. The customer service-related data may include pre-existing data and information extracted from the user call. The pre-existing data may include knowledge base documents related to previous customer requests including solutions and best practices, service instance records from an application monitoring system, and recent activities of the user (e.g., 302 who is making a customer service call).

The integrated data sources may include the back-end data systems 170, an application monitoring system (e.g., the Dynatrace Instances 180), and one or more contact center systems (e.g., 150). The backend data systems 170 may include various backend data APIs which may host pre-existing data including knowledge base documents related to previous customer requests including solutions and best practices, and any applicable recent activities of the user 302.

The Dynatrace Instances 180 may also host preexisting data including service instance records. Although Dynatrace is illustrated here as an example, it should be understood that other suitable application monitoring systems may also be utilized. The data processing model 122 may normalize the pre-existing customer service-related data from the back-end data systems 170 and the Dynatrace Instances 180 through one or more of the following process: API integration connectivity 322, data extraction and normalization 324, and/or data ingestion 326. The normalized pre-existing customer-related data may include internal user navigation, client navigation, client transactions, client activities, knowledge articles and client profile information. The smart call server 110 may then store the normalized pre-existing customer-related data on a local repository (e.g., 130). The data processing model 122 may be configured via custom algorithms to retrieve data in real-time. As will be discussed elsewhere herein, the normalized data may be used to train the generative AI model 124.

Upon receiving a call from the user 302 (e.g., via the user device 190), the contact center 150 may determine a call context/generative model prompt 126. In some examples, the call context may be user information, such as a user’s: name, address, email address, phone number, etc. Additionally or alternatively, the call context may include a task that the user was trying to perform through the automated system and/or an error code/reason for failure in the automated system.

The generative AI model 124 may subsequently receive the call context 126, which it may use partially or wholly as its prompt 126 to generate information related to the user call including determining an intent, a call summary, client recent activities, solutions based on previous recommendations, relevant pre-existing documents, next best actions, co-browsing link, etc. In some embodiments, to generate the co-browsing link, the smart call server (e.g., 110) may send user session information to the contact center system (e.g., 150), generate a co-browsing link connecting the agent (e.g., 304) and the user (e.g., 302), and send the co-browsing link to a smart management system (e.g., 160).

As illustrated, the smart call server may send the generated information including the determined intent to an agent before a user is connected with the agent by processing and organizing the generated information through the smart call management system 160. It should be appreciated that this approach not only reduces the handling time from the agent, but also enhances the quality of customer service by enabling agents to provide more accurate and timely resolutions.

In some embodiments, information related to the present user call may be recorded in one or more of the data sources (e.g., back-end data systems 170, Dynatrace Instances 180). In one example, if the call is completed with the automated system without an agent, the information may be recorded from the contact center system 150. In one example, if the call is routed to an agent, the information may be recorded from the smart call management system 160. The information recorded may include the user's account information, the user's intent, whether the call was completed with the automated system, whether the user's request was completed, and the resolution to the user's request. In some embodiments, the resolution may be consolidated into a part of the knowledge articles. In some embodiments, the user intent and resolution may be recorded as newly added client activities. In one example, if the user updated the user profile information during the call, the updated account information is recorded.

### Exemplary Computer-Implemented Methods – Smart Call Management

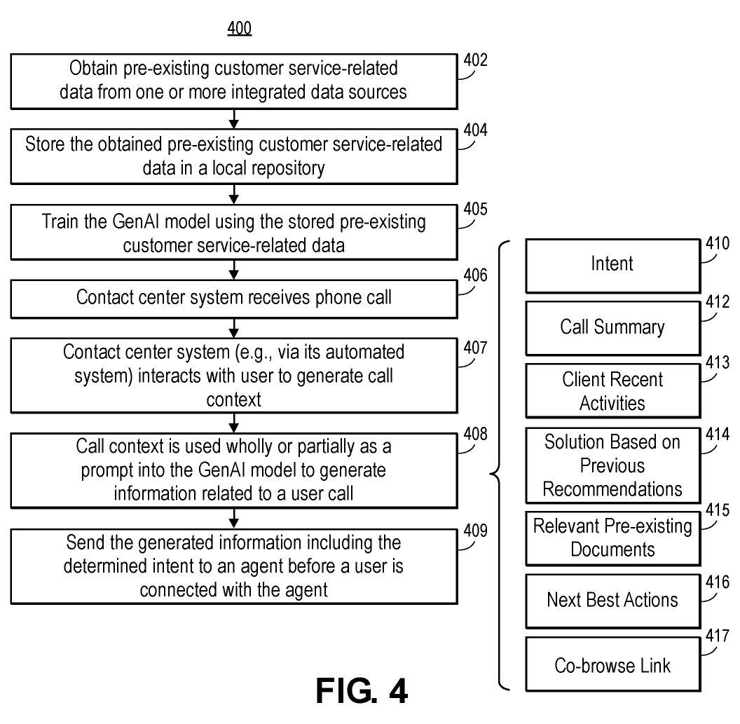

FIG. 4 depicts a flow diagram of an example computer-implemented method for smart call management to improve agent-user interactions, according to one embodiment. In some examples, one or more operations of the example method 400 may be implemented as a set of instructions stored on a non-transitory computer readable storage medium (e.g., memory 120) and executable on one or more processors (e.g., processor 112).

The method 400 may begin at block 402 with the smart call server 110 obtaining pre-existing customer service-related data from one or more integrated data sources. In some examples, the pre-existing customer service-related data may include knowledge base documents related to previous customer requests including solutions and best practices, service instance records from an application monitoring system, and recent activities of the user. Further, in some examples, the integrated data source may include back-end data systems (e.g., 170) and/or application monitoring system(s). An example of an application monitoring system is Dynatrace Instances (e.g., 180), which may keep service instance records. The back-end data systems may keep records of recent activities of users, including the user who initiates the call (e.g., 302). The back-end data systems 170 may further maintain knowledge base documents related to previous customer requests including solutions and best practices.

The method 400 may continue at block 404 with storing the obtained pre-existing customer service-related data in a local repository (e.g., 130). In some embodiments, block 404 may occur as the data ingestion process 326 utilizing the data processing model 122. In some embodiments, prior to storing, the data processing model 122 may extract and normalize the pre-existing customer service-related data (e.g., 324). Storing the normalized data may improve consistency, performance and ease of retrieval of the data. In some embodiments, the data processing model may be configured to run automatically at a predetermined interval.

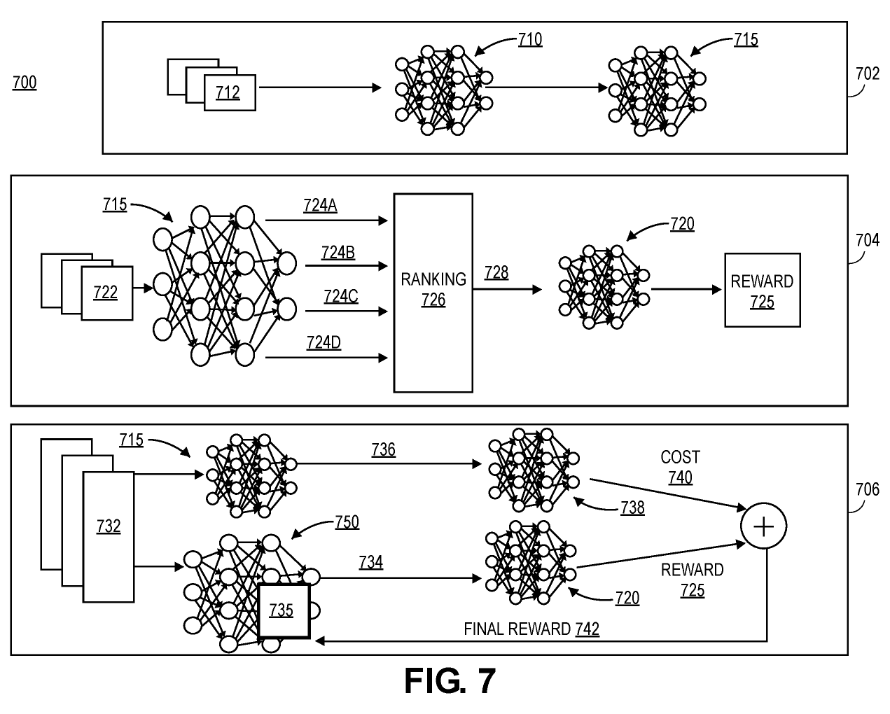

At block 405, the method 400 may further train the generative AI model using the stored pre-existing customer service-related data. For example, as the data processing model automatically updates and stores newly added client activities, knowledge articles, client profile information and other normalized pre-existing customer-related data, the smart call server may train the generative AI model with the updated information. Training processes will be described elsewhere herein (e.g., with respect to FIG. 7).

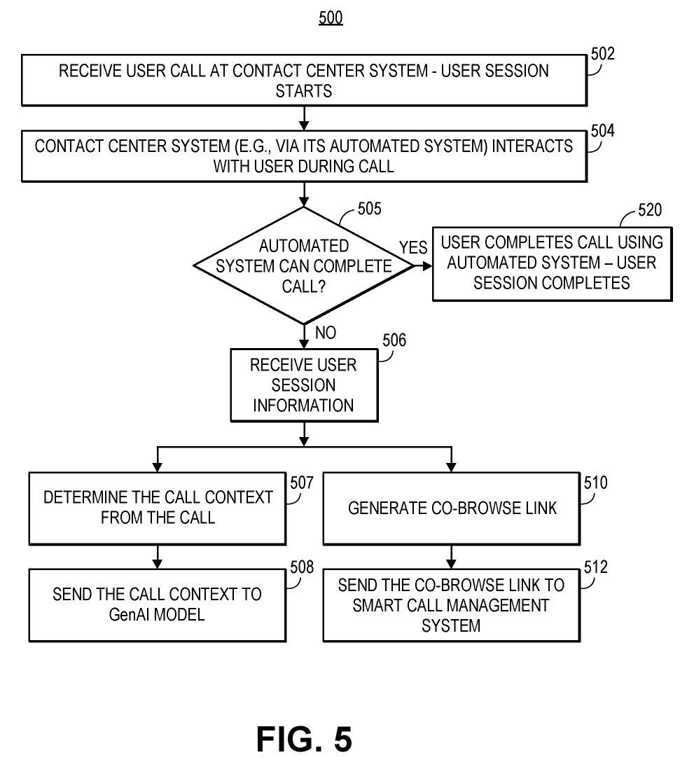

At block 406 the contact center system may receive a phone call from the user 302 and then interact with the user to generate call context (block 407). More details about this process are described below with respect to FIG. 5.

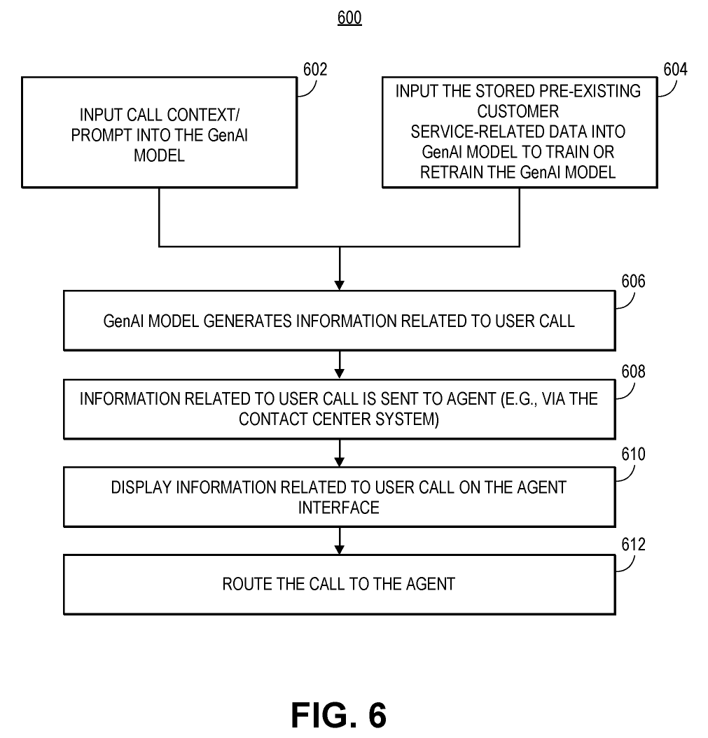

The method 400 may continue at block 408 where the call context is used wholly or partially as a prompt into the generative AI model to generate information related to a user call. In some embodiments, the smart call server 110 may input call context (e.g., 126) into a generative AI model (e.g., 124) (e.g., a generative AI model included in a chatbot or voicebot), which is described in greater detail below with respect to FIGS. 5 and 6. In some embodiments, the generative AI model may be trained by inputting the stored pre-existing customer service data. Further, in some embodiments, the information related to a user call may include intent 410, call summary 412, client recent activities 413 (e.g., client recent transactions; web or mobile activities, such as adding beneficiary, changing distributions, tax forms etc.; etc.), solution based on previous recommendations 414 (e.g., from a solutions database and/or the memory 120, so that recommendations can be provided for similar scenarios), relevant pre-existing documents 415 (e.g., knowledge articles for different: processing rules, plan rules, etc.), or next best actions 416 (e.g., suggestions for new products/investments based on recent history and/or opportunity). In some embodiments, the information related to a user call may further include co-browse link 417 which connects the agent (e.g., 304) and the user (e.g., 302) and may allow the agent to view the user device interface (e.g., 196) on the agent interface (e.g., 260). Generating the co-browse link is described in greater details below with respect to FIG. 5.

The example method 400 may continue at block 409 with sending the generated information related to the user call to an agent before the user 302 is connected with the agent 304. In some embodiments, sending the generated information related to the user call may include processing and organizing the generated information related to the user call through a smart call management system (e.g., 160). The agent 304 may view the generated information on the agent interface (e.g., 200) before the user 302 is connected with the agent 304.

FIG. 5 depicts a flow diagram of an example computer-implemented method 500 for processing user session information in a contact center system, according to one embodiment. A user session starts when a user initiates contact for support. In some embodiments, the user (e.g., 302) may contact a service provider through a phone call. Alternatively or additionally, the user may contact the service provider through the service provider's website via the user interface (e.g., 196). Other means of contact for support may include chat or email. At block 502, the contact center systems (e.g., 150) may receive a user call. In some embodiments, the user 302 may be calling with an intent to change an address, change a phone number, upload a document, or change a beneficiary. Some examples of the contact center systems may include Google CCAI and/or Genesys.

The example method 500 may continue at block 504, where the contact center system 150 may interact with the user 302. For example, the contact center system 150 may be equipped with an automated system to prompt the user to input information related to the call (e.g., by speaking into the phone or by pressing numbers on a keypad, etc.). In some embodiments, at decision block 505, the contact center system 150 may determine whether the automated system can complete the user call including fulfilling the user request. In the example of a user requesting to change address, if the user successfully follows the prompt from the automated system to provide the required information (e.g., user account information, new address, etc.), and confirms that the automated system accurately captured the provided information, the contact center system 150 may determine that the user may complete the request with the automated system without being connected to an agent. In such case, as at block 520, the automated system completes the user request and ends the user call, which completes the user session.

In some embodiments, the contact center system 150 may determine that a user request cannot be completed with the automated system and may require additional assistance, as at block 506. In one example, the contact center may determine that the user call cannot be completed by the automated system if the automated system prompts the user for an input but does not receive any user input within a pre-determined period of time. Alternatively or additionally, the user may fail to make a selection of menu options provided by the automated system (e.g., going back and forth between menu options without making a selection) which prevents the automated system from proceeding with completing the user request. In some examples, the contact center system 150 may determine not to complete the call with the automated system if the user indicates a desire to be connected to an agent instead of using the automated system (e.g., user may give commend of "representative" or other trigger word(s) verbally or through the user interface). In some examples, the automated system may have trouble accurately capturing necessary information provided by the user (e.g., background noise prevents the automated system from discerning the address the user attempted to communicate, as in the example of FIG. 2). In such scenarios, the contact center system 150 may determine that a user request cannot be completed with the automated system. The contact system may then proceed to collect and organize user session information including the user input information and other information related to the call (e.g., automatically captured information including time of the call, issue details for failure to complete the call with the automated system (e.g., 230), etc.). In some embodiments, the contact center system 150 may identify issues that prevent the user call from being automatically completed. In an example where the user intends to change address (as similarly illustrated in FIG. 2), the user may not be able to complete the request with the automated system due to the issue of background noise which prevented the automated system from discerning the address the user attempted to communicate.

Another example of the determination that a user request cannot be completed is high risk authentication. For example, additional security measures may have been triggered due to behavior deemed to be potentially fraudulent or unauthorized. Examples of the triggers include: a login attempt from an unauthorized location, an access attempt from a new or unrecognized device, multiple login attempts within a short period of time from distant locations (e.g., impossible travel time, etc.), etc.

The contact center system may continue, at block 507, to determine the call context based on the received user session information and send the call context to the generative AI model (e.g., 124) (block 508). Alternatively or additionally, if the user 302 is on an eligible website and accepts co-browse, the contact center system 150 may generate a co-browse link (block 510) and send the co-browse link to the smart call management system (block 512).

FIG. 6 depicts a flow diagram of generating information related to a user call using generative AI model 126, according to one embodiment. At block 602, the smart call server may input the call context into the generative AI model 126. As described earlier, in some embodiments, the call context may be used partially or wholly as a generative model prompt to be input into the generative AI model 126. Alternatively or additionally, at block 604, the smart call server may input the stored pre-existing customer service-related data into the generative AI model to train or retrain the generative AI model. Training processes will be described elsewhere herein (e.g., with respect to FIG. 7).

At block 606, the generative AI model may generate information related to a user call. In some examples, as at block 608, the system 100 may send the generated information related to a user call to an agent (e.g., 304). In some embodiments, the generated information related to the user call may be sent via the contact center system 150. In some embodiments, as at block 610, the agent interface 166 may display the information related to the user call, as illustrated by the example in FIG. 2. As in the example of FIG. 2 where the user intends to change address, the generated information related to the user call displayed on the agent interface may include the name of the user, the user intent, issue details for failure to complete the intended request via the automated system (due to the issue of background noise which prevented the automated system to discern the address the user attempted to communicate), issue resolution, and options to initiate co-browsing session. The system 100 may then route the call to an agent 304 (block 612). In some examples, the call is routed from the AI model 124 to the agent 304 via the contact center system 150 and the smart call manager 160 as in the example of FIGS. 3A and 3B.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Example Training Of An Example Chabot

Some embodiments use a chatbot included in or including the AI and/or ML model 124. The chatbot may, inter alia, provide tailored, conversational-like services (e.g., explaining to a user how to or helping with how to change an address, explaining to an agent why a user could not complete an action, etc.). The chatbot may be capable of understanding requests, providing relevant information, escalating issues, etc. Additionally, the chatbot may generate data from interactions which the enterprise may use to personalize future support and/or improve the chatbot’s functionality, e.g., when retraining and/or fine-tuning the chatbot. Moreover, although the following discussion may refer to an ML chatbot or an ML model, it should be understood that it applies equally to an AI chatbot or an AI model.

The chatbot may be trained by any suitable component (e.g., the one or more processors 112, the one or more processors 162, etc.) using large training datasets of text which may provide sophisticated capability for natural-language tasks, such as answering questions and/or holding conversations. The chatbot may include a general-purpose pretrained LLM which, when provided with a starting set of words (prompt) as an input, may attempt to provide an output (response) of the most likely set of words that follow from the input. In some examples, the input prompt is the call context 126 or is included in the call context 126.

In one aspect, the prompt may be provided to, and/or the response received from, the chatbot and/or any other ML model, via a user interface of the smart call server 110, the agent interface 166, etc. This may include a user interface device operably connected to the server via an I/O module. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances, which may require the chatbot to keep track of an entire conversation history as well as the current state of the conversation. The chatbot may rely on various techniques to engage in conversations with users, which may include the use of short-term and long-term memory. Short-term memory may temporarily store information (e.g., in the memory 120, etc.) that may be required for immediate use and may keep track of the current state of the conversation and/or to understand the user’s latest input in order to generate an appropriate response. Long-termmemory may include persistent storage of information (e.g., memory 120, etc.) which may be accessed over an extended period of time. The long-term memory may be used by the chatbot to store information about the user (e.g., preferences, chat history, etc.) and may be useful for improving an overall user experience by enabling the chatbot to personalize and/or provide more informed responses.

In some embodiments, the system and methods to generate and/or train an ML chatbot model which may be used in the chatbot, may include three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning ML Model

As an initial matter, although the discussion with respect to FIG. 7 refers to ML model 750, it should be understood that 750 may refer equally to an AI and/or ML algorithm and/or model.

FIG. 7 depicts a combined block and logic diagram 700 for training an ML chatbot model, in which the techniques described herein may be implemented, according to some embodiments. It should be understood that FIG. 7 may apply to training any chatbot described herein. In addition, the chatbot may be trained in accordance with any of the other techniques described herein; and the training of chatbot should not be considered restricted to the teachings of FIG. 7.

Some of the blocks in FIG. 7 may represent hardware and/or software components, other blocks may represent data structures or memory storing these data structures, registers, or state variables (e.g., 712), and other blocks may represent output data (e.g., 725). Input and/or output signals may be represented by arrows labeled with corresponding signal names and/or other identifiers. The methods and systems may include one or more blocks 702, 704, 706, which will be described in further detail below.

In one aspect, at block 702, a pretrained language model 710 may be fine-tuned. The pretrained language model 710 may be obtained at block 702 and be stored in a memory, such as memory 120. The pretrained language model 710 may be loaded into an ML training module at block 702 for retraining/fine-tuning. A supervised training dataset 712 may be used to fine-tune the pretrained language model 710 wherein each data input prompt to the pretrained language model 710 may have a known output response for the pretrained language model 710 to learn from. The supervised training dataset 712 may be stored in a memory at block 702, e.g., the memory 120. In one aspect, the data labelers may create the supervised training dataset 712 prompts and appropriate responses. The pretrained language model 710 may be fine-tuned using the supervised training dataset 712 resulting in the SFT ML model 715 which may provide appropriate responses to user prompts once trained. The trained SFT ML model 715 may be stored in a memory, such as the memory 120.

In one aspect, the supervised training dataset 712 may include prompts and responses which may be relevant to agent 304 and/or user 302. Examples of prompts include call contexts.

### Training The Reward Model

In one aspect, training the ML chatbot model 750 may include, at block 704, training a reward model 720 to provide, as an output, a scaler value/reward 725. The reward model 720 may be required to leverage Reinforcement Learning with Human Feedback (RLHF) in which a model (e.g., ML chatbot model 750) learns to produce outputs which maximize its reward 725, and in doing so may provide responses which are better aligned to user prompts.

Training the reward model 720 may include, at block 704, providing a single prompt 722 to the SFT ML model 715 as an input. The input prompt 722 may be provided via an input device (e.g., a keyboard) of the smart call server 110 or smart call management system 160. The prompt 722 may be previously unknown to the SFT ML model 715, e.g., the labelers may generate new prompt data, the prompt 722 may include testing data stored on memory 120, and/or any other suitable prompt data. The SFT ML model 715 may generate multiple, different output responses 724A, 724B, 724C, 724D to the single prompt 722. At block 704, the smart call server 110 or smart call management system 160 may output the responses 724A, 724B, 724C, 724D via any suitable technique, such as outputting via a display (e.g., as text responses), a speaker (e.g., as audio/voice responses), etc., for review by the data labelers.

The data labelers may provide feedback (e.g., via the smart call server 110 or smart call management system 160, etc.) on the responses 724A, 724B, 724C, 724D when ranking 726 them from best to worst based upon the prompt-response pairs. The data labelers may rank 726 the responses 724A, 724B, 724C, 724D by labeling the associated data. The ranked prompt-response pairs 728 may be used to train the reward model 720. In one aspect, the smart call server 110 or smart call management system 160 may load the reward model 720 and train the reward model 720 using the ranked response pairs 728 as input. The reward model 720 may provide as an output the scalar reward 725.

In one aspect, the scalar reward 725 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 720 may generate a winning reward. Inputting a “losing” prompt-response pair data to the same reward model 720 may generate a losing reward. The reward model 720 and/or scalar reward 736 may be updated based upon labelers ranking 726 additional prompt-response pairs generated in response to additional prompts 722.

In one example, a data labeler may provide to the SFT ML model 715 as an input prompt 722, “Describe the sky.” The input may be provided by the labeler (e.g., via the smart call server 110 or smart call management system 160, etc.) to the chatbot utilizing the SFT ML model 715. The SFT ML model 715 may provide as output responses to the labeler (e.g., via their respective devices): (i) “the sky is above” 724A; (ii) “the sky includes the atmosphere and may be considered a place between the ground and outer space” 724B; and (iii) “the sky is heavenly” 724C. The data labeler may rank 726, via labeling the prompt-response pairs, prompt-response pair 722/724B as the most preferred answer; prompt-response pair 722/724A as a less preferred answer; and prompt-response 722/724C as the least preferred answer. The labeler may rank 726 the prompt-response pair data in any suitable manner. The ranked prompt-response pairs 728 may be provided to the reward model 720 to generate the scalar reward 725. It should be appreciated that this facilitates training the chatbot to compose explanations of why users could not complete actions, etc.

While the reward model 720 may provide the scalar reward 725 as an output, the reward model 720 may not generate a response (e.g., text). Rather, the scalar reward 725 may be used by a version of the SFT ML model 715 to generate more accurate responses to prompts, i.e., the SFT model 715 may generate the response such as text to the prompt, and the reward model 720 may receive the response to generate a scalar reward 725 of how well humans perceive it. Reinforcement learning may optimize the SFT model 715 with respect to the reward model 720 which may realize the configured ML chatbot model 750.

### RLHF To Train The ML Chatbot Model

In one aspect, the smart call server 110 or smart call management system 160 may train the ML chatbot model 750 (e.g., via the one or more processors 112, the one or more processors 162, etc.) to generate a response 734 to a random, new and/or previously unknown user prompt 732. To generate the response 734, the ML chatbot model 750 may use a policy 735 (e.g., algorithm) which it learns during training of the reward model 720, and in doing so may advance from the SFT model 715 to the ML chatbot model 750. The policy 735 may represent a strategy that the ML chatbot model 750 learns to maximize its reward 725. As discussed herein, based upon prompt-response pairs, a human labeler may continuously provide feedback to assist in determining how well the ML chatbot’s 750 responses match expected responses to determine rewards 725. The rewards 725 may feed back into the ML chatbot model 750 to evolve the policy 735. Thus, the policy 735 may adjust the parameters of the ML chatbot model 750 based upon the rewards 725 it receives for generating good responses. The policy 735 may update as the ML chatbot model 750 provides responses 734 to additional prompts 732.

In one aspect, the response 734 of the ML chatbot model 750 using the policy 735 based upon the reward 725 may be compared using a cost function 738 to the SFT ML model 715 (which may not use a policy) response 736 of the same prompt 732. At block 706 a cost 740 may be computed based upon the cost function 738 of the responses 734, 736. The cost 740 may reduce the distance between the responses 734, 736, i.e., a statistical distance measuring how one probability distribution is different from a second, in one aspect the response 734 of the ML chatbot model 750 versus the response 736 of the SFT model 715. Using the cost 740 to reduce the distance between the responses 734, 736 may avoid a server over-optimizing the reward model 720 and deviating too drastically from the human-intended/preferred response. Without the cost 740, the ML chatbot model 750 optimizations may result in generating responses 734 which are unreasonable but may still result in the reward model boutputting a high reward 725.

In one aspect, the responses 734 of the ML chatbot model 750 using the current policy 735 may be passed to the rewards model 720, which may return the scalar reward or discount 725. The ML chatbot model 750 response 734 may be compared via cost function 738 to the SFT ML model 715 response 736 to compute the cost 740. A final reward 742 may be generated which may include the scalar reward 725 offset and/or restricted by the cost 740. The final reward or discount 742 may be provided to the ML chatbot model 750 and may update the policy 735, which in turn may improve the functionality of the ML chatbot model 750.

To optimize the ML chatbot model 750 over time, RLHF via the human labeler feedback may continue ranking 726 responses of the ML chatbot model 750 versus outputs of earlier/other versions of the SFT ML model 715, i.e., providing positive or negative rewards 725. The RLHF may allow the training process to continue iteratively updating the reward model 720 and/or the policy 735. As a result, the ML chatbot model 750 may be retrained and/or fine-tuned based upon the human feedback via the RLHF process, and throughout continuing conversations may become increasingly efficient.

Although multiple blocks 702, 704, 706 are depicted in the exemplary block and logic diagram 700, each providing one of the three steps of the overall ML chatbot model 750 training, fewer and/or additional blocks may be utilized and/or may provide the one or more steps of the chatbot training. In some variations, each block 702, 704, 706 represents one or more servers (e.g., each server performs a different training stage, etc.).

### Other matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean…” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer-implemented method for optimizing customer service efficiency, comprising:
obtaining, via one or more processors, pre-existing customer service-related data from one or more integrated data sources;
storing, via the one or more processors, the obtained pre-existing customer service-related data in a local repository;
generating, via the one or more processors, by inputting a call context into a generative artificial intelligence (AI) model, information related to a user call including: an intent, a call summary, client recent activities, solutions based on previous recommendations, relevant pre-existing documents, and/or next best actions, wherein the generative AI model was trained by inputting the stored pre-existing customer service data into the generative AI model; and
sending, via the one or more processors, the generated information related to a user call to an agent before a user is connected with the agent.

2. The computer-implemented method of claim 1, wherein the generated information related to the user call further comprises:
a co-browse link connecting the agent and the user.

3. The computer-implemented method of claim 2, further including:
generating, via a contact center system, the co-browse link connecting the agent and the user; and
sending, via the contact center system, the co-browse link to a smart call management system.

4. The computer-implemented method of claim 1, wherein the pre-existing customer service-related data includes:
knowledge base documents related to previous customer requests including solutions and best practices;
service instance records from an application monitoring system; and
recent activities of the user.

5. The computer-implemented method of claim 1, wherein the one or more integrated data sources include:
back-end data systems; and
an application monitoring system.

6. The computer-implemented method of claim 1, further including:
inputting, by the one or more processors, additional stored pre-existing customer service-related data into the generative AI model to further train the generative AI model.

7. The computer-implemented method of claim 1, further including:
determining, at a contact center system, that a user request cannot be completed with an automated system; and
in response to the determining that the user request cannot be completed, sending the call context to the generative AI model.

8. The computer-implemented method of claim 7, wherein determining that a user request cannot be completed with an automated system comprises:
detecting, at a contact center system, that the user fails to complete an action within a pre-determined time period; or
detecting, at the contact center system, that the automated system fails to capture necessary information to complete the user request.

9. The computer-implemented method of claim 1, wherein the intent is an intent to:
change an address;
change a phone number;
upload a document; or
change a beneficiary.

10. The computer-implemented method of claim 1, further including:
prior to the storing, normalizing, via the one or more processors, the customer service-related data from the one or more integrated data sources; and
training, via the one or more processors, the generative AI model by inputting the normalized customer service-related data into the generative AI model.

11. The computer-implemented method of claim 1, further including:
receiving, at a contact center system, a call from a user device; and
determining, at the contact center system, the call context from the call.

12. A computing system for optimizing customer service efficiency, the system comprising:
one or more processors; and
one or more memories, having stored thereon instructions that, when executed, cause the one or more processors to:
obtain pre-existing customer service-related data from one or more integrated data sources;
store the obtained pre-existing customer service-related data in a local repository;
generate, by inputting a call context into a generative artificial intelligence (AI) model, information related to a user call including: an intent, a call summary, client recent activities, solutions based on previous recommendations, relevant pre-existing documents, and/or next best actions, wherein the generative AI model was trained by inputting the stored pre-existing customer service data into the generative AI model; and
send the generated information related to a user call to an agent before a user is connected with the agent.

13. The computing system of claim 12, wherein the generated information related to the user call further comprises:
a co-browse link connecting the agent and the user.

14. The computing system of claim 13, wherein, the instructions, when executed, cause the one or more processors to:
generate, via a contact center system, the co-browse link connecting the agent and the user; and
send, via the contact center system, the co-browse link to a smart call management system.

15. The computing system of claim 12, wherein the instructions, when executed, cause the one or more processors to further:
input additional stored pre-existing customer service-related data into the generative AI model to further train the generative AI model.

16. The computing system of claim 12, wherein the instructions, when executed, cause the one or more processors to further:
determine, at a contact center system, that a user request cannot be completed with an automated system; and
in response to the determining that the user request cannot be completed, send the call context to the generative AI model.

17. The computing system of claim 12, wherein to determine that a user request cannot be completed with an automated system, the instructions, when executed, cause the one or more processors to:
detect, at a contact center system, that the user fails to complete an action within a pre-determined time period; or
detect, at the contact center system, that the automated system fails to capture necessary information to complete the user request.

18. The computing system of claim 12, wherein the instructions, when executed, cause the one or more processors to further:
prior to the storing, normalize the customer service-related data from the one or more integrated data sources; and
train the generative AI model by inputting the normalized customer service-related data into the generative AI model.

19. The computing system of claim 12, wherein the instructions, when executed, cause the one or more processors to further:
receive, at a contact center system, a call from a user device; and
determine, at the contact center system, the call context from the call.

20. A non-transitory computer-readable medium having stored thereon a set of executable instructions that, when executed, cause a computer to:
obtain pre-existing customer service-related data from one or more integrated data sources;
store the obtained pre-existing customer service-related data in a local repository;
generate, by inputting a call context into a generative artificial intelligence (AI) model, information related to a user call including: an intent, a call summary, client recent activities, solutions based on previous recommendations, relevant pre-existing documents, and/or next best actions, wherein the generative AI model was trained by inputting the stored pre-existing customer service data into the generative AI model; and
send the generated information related to a user call to an agent before a user is connected with the agent.

21. The non-transitory computer-readable medium of claim 20, wherein the set of executable instructions, when executed, further cause the computer to:
prior to the user being connected with the agent, pre-fill the generated information on a display device of the agent.
